(19) United States
(12) Patent Application Publication
(10) Pub. No.: US 2026/0344765 A1
(43) Pub. Date: Nov. 5, 2026

(54) An Aerosol Generating Device Comprising a Vacuum Chamber

(71) Applicant: JT International SA, Geneva (CH)

(72) Inventor: Eduardo Jose Garcia Garcia, Le Grand Sconnex (CH)

(73) Assignee: JT International SA, Geneva (CH)

(21) Appl. No.: 19/487,274

(22) PCT Filed: Jun. 25, 2024
(86) PCT No.: PCT/EP2024/067769

§ 371 Date: Nov. 24, 2025

(30) Foreign Application Priority Data
Jun. 30, 2023 (EP) 23182841.9

(51) Int. Cl. A24F 40/46; A24F 40/70

(52) U.S. Cl. CPC A24F 40/46; A24F 40/70

(57) ABSTRACT

Disclosed herein is an aerosol generating device. The aerosol generating device includes a vacuum chamber and a heater. The vacuum chamber may be defined between a plurality of walls. Each wall of the plurality of walls has an internal surface. The heater may be provided on at least one of the walls of the vacuum chamber. The heater may be disposed within the vacuum chamber. The aersol generating device may further include one or more electrical connections. The heater may be electrically connected to a power source provided external to the vacuum chamber through at least one of the walls of the vacuum chamber using the one or more electrical connections. The aerosol generating device may also include a coating provided on one or more of the heater, the one or more electrical connections or any of the internal surfaces to prevent outgassing into the vacuum chamber.

### FIELD OF THE INVENTION

The present invention relates to an aerosol generating device comprising a vacuum chamber. More specifically, the present invention relates to an aerosol generating device comprising a vacuum chamber, wherein a heater is disposed within the vacuum chamber.

### BACKGROUND

It is a developing field of interest to produce electronic cigarettes that heat, but do not burn, a solid or semi-solid aerosol forming substrate which comprises tobacco. One issue in these devices is that a heater which supplies heat to a heating chamber can also undesirably heat the remainder of the device. In compact devices this can be disadvantageous because the temperature of the outer surfaces of the device, which are held by a user, can become unacceptably high. In order to mitigate these effects some aerosol generating devices have been provided with vacuum chambers that can space the heater from the outer surfaces of such devices. This can provide thermal separation between the heating chamber and the outer surfaces which are held by a user. The heater can be disposed within the vacuum chamber along with electrical connections which connect the heater to a power source provided external to the vacuum chamber.

It is important that a vacuum state is maintained in the vacuum chamber so that heat transfer via gases in the chamber can be minimised. The term vacuum used herein may not necessarily refer to a completely evacuated space. The vacuum state within the vacuum chamber may be a low, mid, or high-grade vacuum. There may be some trace amounts of gases within the vacuum chamber, for example. Generally, the vacuum state should be held at a sufficiently low pressure such that heat transfer from the heater to the outer surfaces of the device is reduced. A small quantity of heat transfer may be tolerated.

There is a demand for producing aerosol generating devices that include vacuum chambers that have a vacuum state that will be preserved for sustained periods of time. It is an object of the present invention to provide an aerosol generating device that addresses these requirements.

### SUMMARY OF INVENTION

Described herein is an aerosol generating device, comprising: a vacuum chamber defined between a plurality of walls, the plurality of walls each having internal surfaces; and a heater provided on at least one of the walls of the vacuum chamber, wherein the heater is disposed within the vacuum chamber; one or more electrical connections, wherein the heater is electrically connected to a power source provided external to the vacuum chamber through at least one of the walls of the vacuum chamber using the one or more electrical connections; and a coating, wherein the coating is provided on one or more of the heater, the one or more electrical connections, and any of the internal surfaces, thereby to prevent outgassing into the vacuum chamber.

In an aspect of the present invention there is provided an aerosol generating device, comprising: a vacuum chamber defined between a plurality of walls, the plurality of walls each having internal surfaces; and a heater provided on at least one of the walls of the vacuum chamber, wherein the heater is disposed within the vacuum chamber; one or more electrical connections, wherein the heater is electrically connected to a power source provided external to the vacuum chamber through at least one of the walls of the vacuum chamber using the one or more electrical connections; and a coating, wherein the coating is provided on the one or more electrical connections, thereby to prevent outgassing into the vacuum chamber.

Preferably, the coating is provided on the heater and/or any of the internal surfaces.

It has been found that components of aerosol generating devices, such as the internal walls of the vacuum chambers, heaters, and electrical connections, can outgas when heated, which means that they can release gases. Organic compounds in particular can decompose when heated to cause outgassing.

Heaters and the internal walls of the vacuum chambers may contain trace quantities of organic materials. Furthermore, the materials forming the heaters and the internal walls may begin to decompose into gases when heated. Solder, which is used to connect the electrical connections to the heaters, often contains traces of flux and flux often comprises organic compounds such as naturally occurring resins. Organic compounds in components of the device therefore may cause outgassing into the vacuum chamber during operation of the device, damaging the vacuum state of the vacuum chamber.

In devices wherein the vacuum state is a low-grade vacuum state, trace amounts of gases may be present within the vacuum chamber. However, such a vacuum state may still be effective at preventing significant heat transfer. If outgassing were to occur into such a vacuum state, the amount of gas present within the vacuum chamber would increase and so would the gas pressure. In this scenario the gases outgassed into the vacuum chamber may start to transfer heat which would increase heat transfer to the exterior surfaces of the device.

By coating surfaces within the vacuum chamber, the effect of outgassing can be reduced, thereby maintaining the vacuum state of the vacuum chamber for a sustained period of time. Such coatings suitable for this purpose do not outgas. Coatings suitable for this purpose do not permit gases to flow through them. By coating the surfaces of components of the aerosol generating device disposed within the vacuum chamber, other forms of treatment to remove organic compounds prior to the assembly of the device, such as baking at high temperatures, may not be required.

The coating thickness may be selected in order to satisfy a number of competing interests. A thin coating may be preferable in order to improve thermal insulation provided by the vacuum chamber. On the other hand, the thickness of the coating must be thick enough to provide an impermeable cover that prevents the permeation of gas for an extended period of time, even under high temperature conditions. In some arrangements these factors may be balanced such that the thickness of the coating allows a vacuum state to be maintained for at least a selected time period. In one embodiment the selected time period may be around two years, or at least two years for ordinary use.

In various embodiments, the one or more electrical connections comprise solder. In this way, the electrical connections can easily be connected to the heater. The solder can additionally be coated, thereby preventing outgassing directly from the solder into the vacuum chamber.

In one configuration, the vacuum chamber may be defined between an inner wall, an outer wall, an upper wall, and a lower wall. Preferably, the coating is provided on any of the inner, outer, upper, and lower walls. In this way, outgassing into the vacuum chamber from one or more regions of the walls of the vacuum chamber can be prevented. It should be understood that the internal surfaces of the plurality of walls are those surfaces that face inwardly towards the vacuum chamber.

Preferably, the heater is electrically connected to a power source that is provided externally to the vacuum chamber through the lower wall of the vacuum chamber using the one or more electrical connections. In this way, the operation of heater disposed within the vacuum can be controlled. The construction of the aerosol generating device can also be simplified. Alternatively, the heater may be electrically connected to the power source through any of the inner, outer, and upper walls of the vacuum chamber, or any combination thereof.

The heater may comprise a printed heating element. In this way, the heater may be easily and securely provided on at least one of the walls of the vacuum chamber. Preferably, the heater is provided on the inner wall of the vacuum chamber. In this way, the size of the aerosol generating device can be reduced and its assembly can also be simplified. The printed heater may comprise printed lead pads to which the one or more electrical connections can be connected.

The electrical connections may comprise pogo pins. In this way, the construction of the device may be simplified as the pogo pins can provide an electrical connection through to the heater through the outer wall of the device from a power source provided external to the vacuum chamber. Furthermore, the risk of damaging the heater during assembly of the device is reduced due to the fact that pogo pins may be gently biased towards the heater.

The coating may comprise silicon. It has been found that silicon coatings, in particular, are effective in reducing outgassing.

In another aspect of the invention there is provided a method for forming an aerosol generating device, comprising: forming a vacuum chamber defined between a plurality of walls, the plurality of walls each having internal surfaces; providing a heater on at least one of the walls of the vacuum chamber, wherein the heater is disposed within the vacuum chamber; forming one or more electrical connections, wherein the heater is electrically connected to a power source provided external to the vacuum chamber through at least one of the walls of the vacuum chamber using the one or more electrical connections; and coating the one or more electrical connections, thereby to prevent outgassing into the vacuum chamber.

Preferably, the method further comprises coating the heater and/or any of the internal surfaces, thereby to prevent outgassing into the vacuum chamber.

Preferably, the coating is applied via chemical vapour deposition. In other terms, coating the heater, the one or more electrical connections, and/or any of the internal surfaces comprises coating the heater, the one or more electrical connections, and/or any of the internal surfaces via chemical vapour deposition. In this way, the coating can be applied accurately to components of the aerosol generating device that are to be disposed within the vacuum chamber. By using chemical vapour deposition, a thin film of the coating can be applied to the heater, the one or more electrical connections, and/or any of the internal surfaces.

A silicon coating may be applied via chemical vapour deposition to the heater, the one or more electrical connections, and/or any of the internal surfaces. In examples where only some of the components are to be coated, for example only the heater, the surfaces of the other components may be masked with a material to prevent the coating from being applied to the masked surfaces.

When coating the inner wall of the vacuum chamber, the inner wall may be inverted and placed on or into a jig. The jig may be an array of holes onto or into which components of the device may be placed. This prevents the coating from being applied to an opening, or heating chamber of the cup-shaped inner wall as the heating chamber is not exposed.

The above-described apparatus features may be implemented as method steps in a method of forming an aerosol generating device and vice versa. It should be understood that the steps of the methods described may be performed in a variety of different sequences.

### BRIEF DESCRIPTION OF DRAWINGS

Embodiments of the invention will now be described, by way of example, by reference to the drawings, in which:

FIG. 1 is a schematic cross-sectional diagram of an aerosol generating device comprising a vacuum chamber known in the art;

FIG. 2 is a schematic cross-sectional diagram of an aerosol generating device in an embodiment of the invention;

FIG. 3 is a schematic cross-sectional diagram of an aerosol generating device in another embodiment of the invention; and

FIG. 4 is a schematic cross-sectional diagram of an aerosol generating device in another embodiment of the invention.

### DETAILED DESCRIPTION

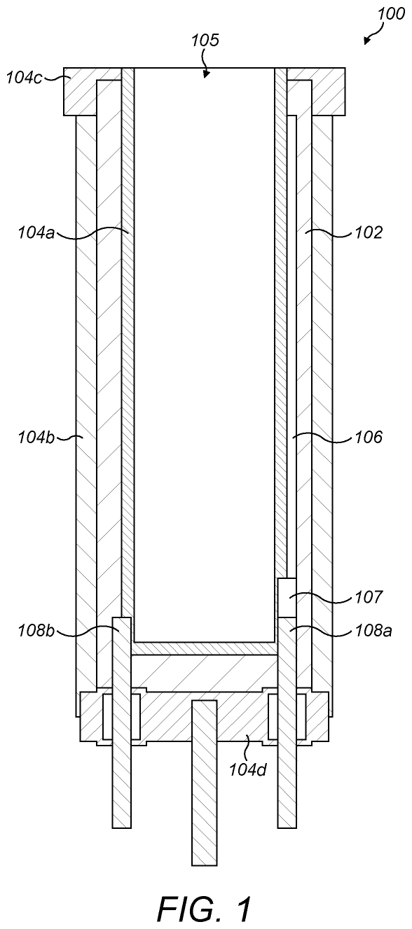

FIG. 1 is a schematic cross-sectional diagram of an aerosol generating device 100 comprising a vacuum chamber 102 known in the art. The aerosol generating device 100 has a generally cylindrical shape with a circular cross-section, defined around a central axis. The vacuum chamber 102 is defined between an inner wall 104a, an outer wall 104b, and upper wall 104c and a lower wall 104d. The walls each have internal surfaces that face inwardly towards the vacuum chamber 102. An opening 105 is provided through the upper wall 104c. The opening 105 extends in an axial direction internally within the cup-shaped inner wall 104a. The opening 105 is configured such that an aerosol generating substrate (not shown) can be received within the inner wall 104a for heating by a heater 106. The heater 106 comprises lead pads 107 and is provided on the inner wall 104a. The heater 106 is disposed within the vacuum chamber 102. A first electrical connection 108a and a second electrical connection 108b are provided through the lower wall 104d to connect the heater 106, via the lead pads 107, to a power source (not shown) that is provided external to the vacuum chamber 102.

In this example, the heater 106 is printed to the inner wall 104a. The heater 106 may contain organic compounds that can decompose when heated. These compounds may release small quantities of gas into the vacuum chamber 102 during decomposition, thus damaging the vacuum state of the vacuum chamber, in a process that is known as outgassing. Furthermore, the first and second electrical connections 108a, b are connected to the heater using a solder. A flux is often used to apply a heated solder to a specific area to form a connection. Fluxes commonly comprise organic compounds such as naturally occurring resins. These naturally occurring resins are also likely to decompose when heated, releasing small quantities of gas into the vacuum chamber 102. These effects can be detrimental to the vacuum state of the vacuum chamber 102.

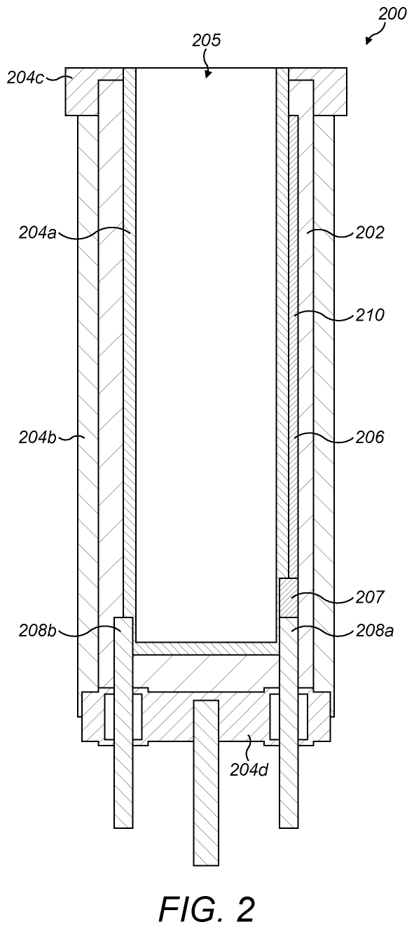

FIG. 2 is a schematic cross-sectional diagram of an aerosol generating device 200 in an embodiment of the invention. The vacuum chamber 202 is defined between an inner wall 204a, an outer wall 204b, and upper wall 204c and a lower wall 204d. The walls each have internal surfaces that face inwardly towards the vacuum chamber 202. An opening 205 is provided through the upper wall 204c. The opening 205 also extends axially within the cup-shaped inner wall 204a. The opening 205 is configured such that an aerosol generating substrate (not shown) can be received within the inner wall 204a for heating by a heater 206. The heater 206 comprises lead pads 207 and is provided on the inner wall 204a. The heater 206 is disposed within the vacuum chamber 202. A first electrical connection 208a and a second electrical connection 208b are provided through the lower wall 204d to connect the heater 206, via the lead pads 207, to a power source (not shown) that is provided external to the vacuum chamber 202. A coating 210 is provided on the heater 206 and the lead pads of the heater 207 to reduce outgassing from compounds within the heater 206 into the vacuum chamber 202. In one example a silicon coating may be provided. The material used for the coating is selected so that it is non-porous and does not contain organic material that could potentially cause outgassing.

In this example, the outer wall 204b, the upper wall 204c and the lower wall 204d are separate components. In other examples, these three components may instead be a single unitary cup-shaped outer wall.

The heater 206 is provided on an outward-facing surface of the inner wall 204a and within the vacuum chamber 202. The outward-facing surface of the inner wall 204 and the inner-facing surface of the outer wall 204b are spaced apart from each other within the vacuum chamber 202. The vacuum chamber 202 therefore insulates the outer wall 204b, and thus a user of the device, from heat produced by the heater 206. Heat from the heater 206 is transferred to the inner wall 204a and by conduction to a consumable that is received within the opening 205. The vacuum chamber 202 is sealed by the top wall 204c and bottom wall 204d.

In this example, the heater 206 is a printed heating element comprising printed lead pads 207 to which the first and second electrical connections 208a, b can be connected to. The heater 206 is printed to the exterior of the inner wall 204a that is to be within the vacuum chamber 202 with an electrically conducting screen print ink which forms the heater. In other examples, the heater 206 may be a wire heating element or another type of heater. The heater 206 is printed in a meandering pattern to provide uniform heating to the inner wall 204a.

The first and second electrical connections 208a, b are provided through the lower wall 204d. In other examples, the first and second electrical connections 208a, b may be provided through the outer wall 204b or the upper wall 204c or through a combination of walls.

In this example, a coating 210 is provided on the heater 206 and on the lead pads of the heater 207 to reduce outgassing into the vacuum chamber. The coating 210 is silicon coating that that is applied to the heater 206 and to the lead pads 207 using chemical vapour deposition.

When applying the coating 210 to the heater 206 and the lead pads 207, the inner wall 204a, the outer wall 204b, the upper wall 204c, the lower wall 204d and the first and second electrical connections 208a, b may be masked with a material to prevent the coating from being applied to these surfaces. The material can then be removed after the coating has been applied, leaving only the heater 206 and the lead pads 207 coated.

The thickness of the coating is selected to provide a particular length of use, during which the coating can continue to prevent outgassing into the vacuum chamber. In some arrangements the particular length of use is at least two years.

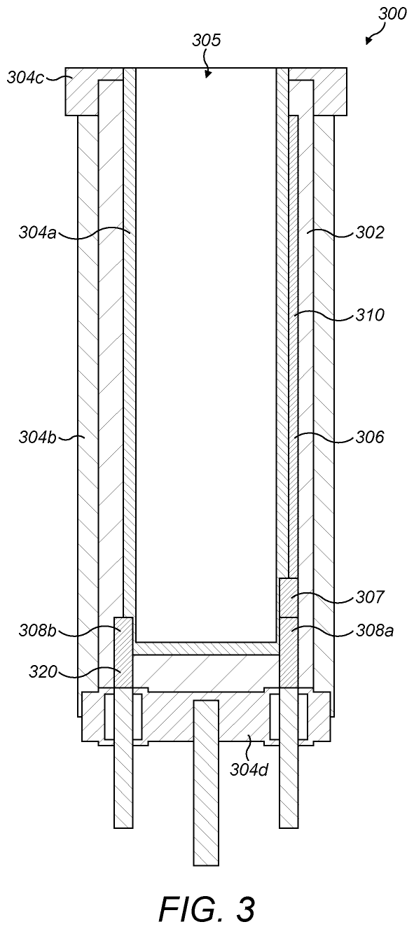

FIG. 3 is a schematic cross-sectional diagram of an aerosol generating device 300 in an embodiment of the invention, which is similar in structure to the embodiment of FIG. 2.

In this configuration, a first coating 310 is provided on the heater 306 and the lead pads 307 to prevent outgassing from compounds within the heater into the vacuum chamber 302 and a second coating 320 is provided on the first and second electrical connections 308a, b to prevent outgassing from compounds within the first and second electrical connections 308a, b into the vacuum chamber 302.

The first and second coatings 310, 320 are silicon coatings that that are applied to the heater 306, the lead pads 307, and to the first and second electrical connections 308a, b using chemical vapour deposition. The first and second coatings 310, 320 are silicon coatings that that are applied using chemical vapour deposition. In some arrangements the first and second coatings 310, 320 may be applied in a single step, and may effectively create a single coating that covers the heater 306, the lead pads 307 and the first and second electrical connections 308a, b.

In a similar manner to that described in the embodiment according to FIG. 2, the walls of the vacuum chamber may be masked with a material when applying the coating to prevent the coating from being applied to the surfaces of the walls.

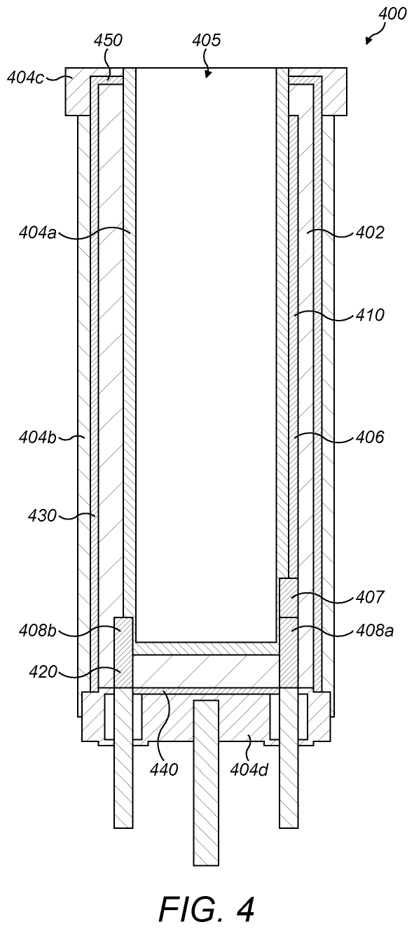

FIG. 4 is another schematic cross-sectional diagram.

In this configuration, a first coating 410 is provided on the heater 406 and the lead pads 407 to prevent outgassing from compounds within the heater into the vacuum chamber 402. A second coating 420 is provided on the first and second electrical connections 408a, b to prevent outgassing from compounds within the first and second electrical connections 408a, b into the vacuum chamber 402.

A third coating 430 is provided on the internal surfaces of the outer wall 404b, a fourth coating 440 is provided on the internal surfaces of the lower wall 404d and a fifth coating is provided on the internal surfaces of the upper wall 404c. The third, fourth and fifth coatings 430, 440, 450 prevent outgassing into the vacuum chamber 402 from the outer wall 404b, the lower wall 404d and the upper wall 404c respectively. The third, fourth and fifth coatings 430, 440, 450 are also silicon coatings that that are applied using chemical vapour deposition. As above, the first, second, third, fourth and fifth coatings 410, 420, 430, 440, 450 may be applied together in a single step so that they form a single coating. Alternatively, one or more of these coatings may be combined with one another, and may be formed from different coating materials, depending on manufacturing preferences.

In this embodiment, the inner wall 404a may be masked with a material to prevent the coating from being applied to the surfaces of the inner wall 204a not covered by the heater 406. In other embodiments a coating may also be provided on the inner wall 404a so that the surfaces that define the vacuum chamber 402 are fully coated together with all of the components that are provided within the vacuum chamber 402. Such a configuration can minimise any risk of outgassing that could compromise the integrity of the vacuum and prevent any change in thermal insulation over time.

1. An aerosol generating device, comprising:
a vacuum chamber defined between a plurality of walls, each wall of the plurality of walls having internal surfaces;
a heater provided on at least one of the walls of the vacuum chamber, wherein the heater is disposed within the vacuum chamber;
one or more electrical connections, wherein the heater is electrically connected to a power source provided external to the vacuum chamber through at least one of the walls of the vacuum chamber using the one or more electrical connections; and
a coating, wherein the coating is provided on the one or more electrical connections to prevent outgassing into the vacuum chamber.

2. The aerosol generating device according to claim 1, wherein the coating is provided on the heater and/or any of the internal surfaces.

3. The aerosol generating device according to claim 1, wherein the one or more electrical connections comprise solder.

4. The aerosol generating device according to claim 1, wherein the plurality of walls include an inner wall, an outer wall, an upper wall, and a lower wall.

5. The aerosol generating device according to claim 4, wherein the coating is provided on any of the internal surfaces of inner, outer, upper and lower walls.

6. The aerosol generating device according to claim 4, wherein the heater is electrically connected to a power source provided external to the vacuum chamber through the lower wall of the vacuum chamber using the one or more electrical connections.

7. The aerosol generating device according to claim 1, wherein the heater comprises a printed heating element.

8. The aerosol generating device according to claim 1, wherein the electrical connections comprise pogo pins.

9. The aerosol generating device according to claim 1, wherein the coating comprises silicon.

10. A method for forming an aerosol generating device, comprising:
forming a vacuum chamber defined between a plurality of walls, each wall of the plurality of walls having internal surfaces;
providing a heater on at least one of the walls of the vacuum chamber, wherein the heater is disposed within the vacuum chamber;
forming one or more electrical connections, wherein the heater is electrically connected to a power source provided external to the vacuum chamber through at least one of the walls of the vacuum chamber using the one or more electrical connections; and
coating the one or more electrical connections to prevent outgassing into the vacuum chamber.

11. The method according to claim 10, further comprising:
coating the heater and/or any of the internal surfaces, thereby to prevent outgassing into the vacuum chamber.

12. The method according to claim 10, wherein the coating is applied via chemical vapour deposition.
